(19) United States
(12) Patent Application Publication
(10) Pub. No.: US 2013/0022795 A1
(43) Pub. Date: Jan. 24, 2013

(54) METHOD FOR HIGH RESOLUTION SUBLIMATION PRINTING

(71) Applicants: BO WANG, Toronto (CA); ANDY LIM, Toronto (CA)

(72) Inventors: BO WANG, Toronto (CA); ANDY LIM, Toronto (CA)

(21) Appl. No.: 13/188,137

(22) Filed: Jul. 21, 2011

(51) Int. Cl. B32B 3/00; B41F 33/00

(52) U.S. Cl. 428/195.1; 101/483

(57) ABSTRACT

A method for printing a high resolution image onto natural fabric such as cotton or cotton blends is provided. The method comprises applying a base coat composition comprising an organosilicon compound to a fabric, drying the fabric to obtain a base coat, and printing a high-resolution image on the base coated fabric. In one embodiment, the printing comprises sublimation printing. A fabric comprising a base coat, and a high resolution printed image, wherein the base coat comprises an intermediary layer between the fabric layer and the high-resolution printed image is also provided.

### FIELD

The invention relates to a method for printing a high resolution image on a fabric, which is preferably a natural fabric. The natural fabric preferably comprises cotton.

### INTRODUCTION

Sublimation printing allows the transfer of high resolution images to fabric.

Sublimation printing is generally known in the art and comprises using heat sensitive dyes (also known as sublimation dyes) to print a desired image onto a transfer substrate. The fabric surface to be printed and the transfer substrate are then heat pressed at a high temperature. The heat causes the solid dye contained on the transfer substrate to vaporize into a gas. At the same time, the pores of the fabric open and allow the dye vapour to enter the fabric. As the temperature drops, the fibers close and the gas reverts to a solid state, trapping the dye in the fabric. As a result, the image is transferred to the fabric.

There are limitations to the use of sublimation printing. In particular, while sublimation printing produces high quality, bright images on synthetic fabrics such as polyester, it does not produce images of equal quality on natural fibers such as cotton. Sublimation printing on cotton and cotton blend garments results in faded colours and poor colour-fastness. It has been suggested that the high porosity of cotton compared to polyester fibers may be the basis for the difficulty in applying the sublimation technique to such fabrics.

Methods have been provided in the prior art for sublimation printing on cotton based fabrics. For example, U.S. Pat. No. 4,021,591 (Sublimation transfer and method) relates to a dry release sublimation transfer substrate that allows the application of images to cotton and cotton-polyester fabrics. The process utilizes a polymeric layer that comprises a hydrocarbon. U.S. Pat. No. 4,576,610 (Sublimation dye transfer printing of fabrics) describes the application of a polyester resin to cotton fabric prior to sublimation printing. However, this method can result in a stiff final product.

US Patent Application No. 2010/0035029 (Distortion resistant, high-definition litho applique) discloses the application of appliques comprising high definition images to a garment rather than directly transferring images onto the garment itself. However, the existence of an applique on a garment has a considerable impact on the hand feel of the finished product. In addition, the process involves a number of steps including printing the image, transferring the image, cutting out the image, and affixing the applique to the garment.

### SUMMARY

The following summary is provided to introduce the reader to the more detailed discussion to follow. The summary is not intended to limit or define the claims.

According to one broad aspect of this disclosure, a method is provided for printing a high resolution image on fabric. The method comprises:

(a) applying a base coat composition to a fabric;

(b) drying the fabric to obtain a fabric with a base coat; and,

(c) printing an image on the base coated fabric,

wherein the base coat composition comprises an organosilicon compound.

In one embodiment of the disclosure, the organosilicon compound is a siloxane. Optionally, the siloxane is polydimethylsiloxane.

In another embodiment, the base coat composition further comprises calcium, magnesium, sodium, sulfur or compounds thereof. In an additional embodiment, the base coat composition further comprises a solvent or carrier.

In another embodiment, the base coat composition is applied as a liquid base coat mixture. The liquid base coat mixture may comprise a solution. The solution may include at least one alkali or alkaline earth metal.

In another aspect, the printing comprises sublimation printing. The sublimation printing may comprise transferring ink by heat pressing a transfer substrate and the base coated fabric at, e.g., 375 to 475° F., preferably 400 to 450° F. for 35 to 40 seconds.

In one embodiment, the fabric is a natural fiber, which preferably comprises cotton or a cotton blend such as a blend of cotton and polyester.

In one embodiment, the base coat composition is applied using silk screening.

In one embodiment, the base coated fabric is dried at a temperature of 250 to 400° F. for 15 to 30 seconds.

In one embodiment, the base coat composition is selected to produce the base coat that is not detectable to the human eye.

In another embodiment, the fabric is a light coloured fabric and is preferably white.

In yet another embodiment, the high-resolution image has a resolution of at least 600 DPI.

In another broad aspect of the disclosure, the disclosure relates to a fabric comprising a base coat comprising an organosilicon compound, and a high resolution printed image, wherein the base coat comprises an intermediary layer between the fabric layer and the high resolution printed image.

It will be appreciated that the fabric and the base coat may be of any embodiment previously described. For example, in one embodiment, the organosilicon compound is a siloxane. Optionally, the siloxane is polydimethylsiloxane.

In one embodiment, the base coat further comprises calcium, magnesium, sodium, sulfur or compounds thereof.

In a preferred embodiment of the fabric article, the high resolution printed image is printed by sublimation printing.

In another embodiment, the fabric layer is a natural fiber optionally comprising cotton or a cotton blend such as a blend of cotton and polyester. In a further embodiment, the high-resolution printed image has a resolution of at least 600DPI.

The disclosure also relates to a fabric article produced by the methods described above.

The method provides an efficient and cost-effective method for printing high-resolution images directly on natural fibers such as cotton.

The method may provide a finished product (e.g., a garment) having both a durable, bright, high-resolution image as well as a soft, comfortable hand feel.

### DRAWINGS

Reference is made in the description of various embodiments to the accompanying drawings, in which:

FIG. 1 is a schematic diagram illustrating the process for high resolution fabric printing in accordance with one embodiment of the disclosure;

FIG. 2A depicts a cotton t-shirt printed according to one embodiment of the disclosure; and,

FIG. 2B depicts a cotton t-shirt printed according to a prior art method.

### DESCRIPTION OF VARIOUS EMBODIMENTS

Various processes and compositions will be described below to provide an example of each claimed invention. No invention described below limits any claimed invention and any claimed invention may cover processes and compositions that are not described below. The claimed inventions are not limited to processes and compositions having all of the features of any one process or composition, or to features common to multiple or all of the processes or compositions described below. It is possible that a process or composition described below is not an embodiment of any claimed inventions.

In accordance with the present disclosure, a method is provided for printing a high resolution image on fabric.

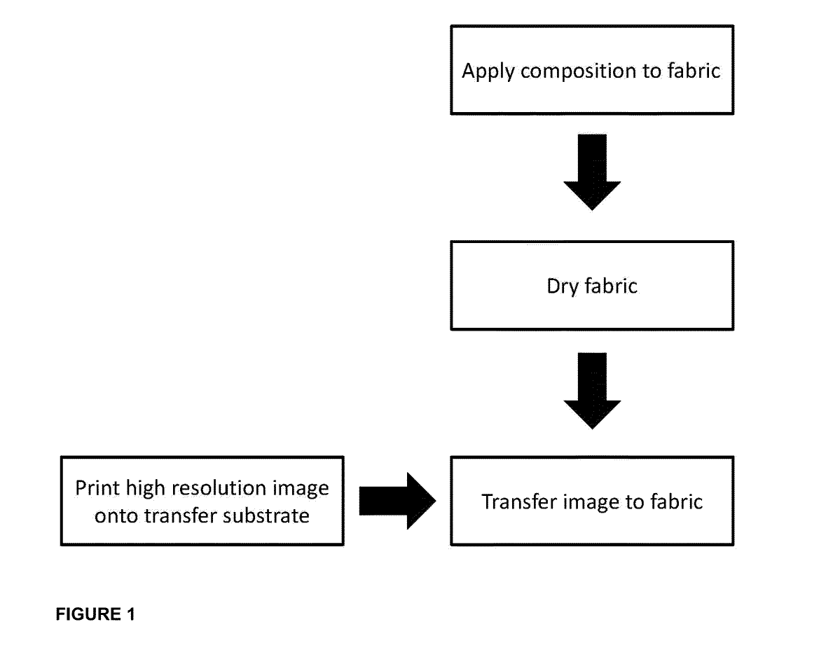

Referring now to FIG. 1, there is shown a process for high resolution fabric printing in accordance with one embodiment of the disclosure.

According to this embodiment, the process comprises providing a fabric to be printed, applying a base coat composition to the fabric, drying the fabric to obtain a fabric with a base coat and printing an image on the coated fabric. In a preferred embodiment, the base coat composition comprises a silicon containing compound such as an organosilicon. The image is preferably printed onto the base coated fabric through sublimation printing, namely printing an image onto a transfer substrate and then transferring the image to the fabric through the use of heat.

The fabric may be made from a natural fiber, a synthetic fiber or a blend thereof. In preferred embodiments, the fabric comprises a natural fiber. The fabric may be made from one or more natural fibers and may optionally be combined with one or more synthetic fibers. The natural fabric may be cotton, wool, hemp, silk and linen or a blend thereof and preferably comprises cotton. The synthetic fiber may be polyester, nylon, lycra, spandex and blends thereof and preferably comprises polyester. An exemplary fabric may be cotton or a cotton blend such as a blend of cotton and polyester. In one particular embodiment, the cotton blend may comprise at least about 50%, preferably at least about 75% and more preferably at least about 95% cotton. In another embodiment, the cotton blend is a blend of cotton and polyester, optionally a blend of 50% cotton and 50% polyester.

In one embodiment of the disclosure, the fabric is light-coloured. Examples of light colours include, but are not limited to, white, off-white, cream, beige, grey and an unbleached natural colour. A preferred colour is white.

In another embodiment, the fabric retains the original fabric colour throughout the process, i.e., the colour of the fabric after the printing process is essentially the same as colour of the fabric prior to the printing process. Accordingly, there is no colour change due to the application of the base coat composition to the fabric and the drying of the fabric to obtain a base coat.

The fabric may be any size that is suitable for printing. Accordingly, the fabric may be a finished product such as a garment. The garment may be a t-shirt, sweat-shirt, tank-top, shorts, pants, socks, bandana, scarf, shawl, hat, dress, or jacket, and is preferably a t-shirt, sweat-shirt, tank-top or shorts. The fabric may also include household items including, but not limited to, towels, clothes, placemats or table clothes.

The base coat composition may be applied to the fabric by way of any method known in the art. For example, the base coat composition may be applied to the fabric by one or more of silk screening, spraying the composition onto the fabric, dipping or submersing the fabric in the base coat composition, brushing or painting the base coat composition onto the fabric, or impregnating the fabric with the composition. In a preferred embodiment, the base coat composition is applied through silk screening. The application of the base coat composition to the fabric may cause the organosilicon to be coated on or impregnated in the fabric.

The base coat composition may be applied to the entire piece of fabric or, optionally, to the specific area of the fabric to which the image is to be applied. The surface area of the fabric to be treated can depend on the size of the image to be printed. Preferably, the surface area of the fabric to be treated is at least as large as the surface area of the image to be printed on the fabric (and is preferably about the same size) such that the image is contained entirely within the treated area. In another embodiment, the surface area of the fabric to be treated is larger than the surface area of the image to be printed.

In a preferred embodiment, the base coat composition is applied to an area of fabric to provide a layer of the base coat composition or a base coat. The base coat may have a thickness of 190 to 230 microns, preferably 105 to 115 microns and most preferably 110 microns. In this manner, 190 to 230 cubic microns, preferably 105 to 115 cubic microns of the base coat composition and most preferably 110 cubic microns may be applied per square meter of fabric to be treated.

In a preferred embodiment of the disclosure, the base coat composition comprises silicon or a silicon-containing compound. Preferably, the silicon-containing compound is an organosilicon compound and, more preferably, a siloxane. Organosilicon compounds are compounds containing silicon-carbon bonds. Examples of organosilicon compounds include, but are not limited to, siloxanes, silanes, siloxides and silyl halides. A siloxane is a chemical compound composed of units of the form R₂SiO, where R is a hydrogen atom or a hydrocarbon group. Polymerized siloxanes with organic side chains are known as silicones or as polysiloxanes. Silicones have the base chemical formula [R₂SiO]ₙ, where R is a hydrogen atom or a hydrocarbon group. Examples of silicones include, but are not limited to, polydimethylsiloxane, polymethylhydrosiloxane, polydiphenylsiloxane, polysilicone-15 and simethicone. The organosilicon compound, siloxane or silicone of the present disclosure is not particularly limited, but includes any organosilicon compound, siloxane or silicone that provides the desired activity.

In an exemplary embodiment, the organosilicon compound is polydimethylsiloxane. Polydimethylsiloxane has the chemical formula CH₃[Si(CH₃)₂O]ₙSi(CH₃)₃, where n is the number of repeating monomer [SiO(CH₃)₂] units.

In one aspect of the disclosure, the base coat is applied as a liquid base coat mixture. The liquid base coat mixture comprises the base coat composition together with a carrier or a solvent and is preferably a solution, preferably an aqueous solution of an organosilicon compound. The solvent or carrier is preferably present in an amount of from 0.1 to 99.9% by weight, based on the total weight of the liquid base coat mixture. Illustrative examples of suitable solvents include, for example, water and mono-alcohols such as methanol, ethanol, isopropanol, and combinations thereof. Optionally, the liquid base coat mixture comprises a dispersing agent, preferably a sodium-based dispersing agent.

In one embodiment, the silicon or silicon containing compound is present in the composition is an amount of 50 to 150 parts per million (ppm), optionally 100 to 110 ppm.

In additional embodiments of the disclosure, the liquid base coat mixture may include at least one alkali or alkaline earth metal. For example, the liquid base coat mixture may further comprise calcium, magnesium, sodium or sulfur or compounds thereof. In another embodiment, the base coat composition further comprises calcium, magnesium, sodium and sulfur or compounds thereof. Optionally, calcium or a calcium containing compound is present in the composition in an amount of 400 to 440 ppm, magnesium or a magnesium containing compound is present in the composition in an amount of 80 to 120 ppm, sodium or a sodium containing compound is present in an amount of 450 to 525 ppm and/or sulfur or a sulfur containing compound is present in an amount of 190 to 250 ppm.

In another embodiment of the disclosure, the base coat composition comprises any one of silicon, calcium, magnesium, sodium or sulfur or compounds thereof. The disclosure further provides compositions comprising any combination of the following: silicon, calcium, magnesium, sodium or sulfur or compounds thereof.

The base coat is preferably a clear base coat that is not readily visible on the surface of the fabric. In a preferred embodiment, a base coated fabric has a soft hand feel.

In a preferred embodiment of the disclosure, the fabric is dried following the application of the base coat composition to obtain a base coat on the fabric. The fabric may be dried such that the solvent is evaporated prior to the printing process. For example, the base coated fabric may be dried at a temperature of 250 to 400° F., and preferably 300 to 350° F., for 15 to 60 seconds, and preferably 35 to 45 seconds. The fabric may be dried by any means known in the art. Conduction, natural convention, forced convention and IR may be used. In one particular embodiment, the fabric is dried by natural or forced convention, such as by subjecting the fabric to heat from a gas-fired oven.

The drying step may comprise removing at least 10, 25, 50, 75 or 95% of the water or other solvent from the treated fabric. In another embodiment, the drying step comprises curing or setting the base coat to the fabric. In another embodiment, the drying step comprises removing the solvent or carrier, e.g., water from the base coated fabric such that it is no longer wet or damp to the touch.

Following the drying step, the image is printed onto the treated fabric. In a preferred embodiment of the disclosure, the image is printed onto the fabric using sublimation printing. Any method of sublimation printing known in the art may be used in the present process.

In one aspect of the disclosure, sublimation printing comprises:

(a) printing an image onto a transfer substrate using sublimation inks; and,

(b) applying the transfer substrate to the fabric under applied heat and pressure to transfer the sublimation inks to the fabric.

According to one embodiment, an image, preferably a high-resolution image (e.g., greater than 100 DPI, 300 DPI, 600 DPI or preferably 720 DPI, i.e., dots per inch) is prepared using an appropriately programmed computer. An exemplary program that may be used is Adobe Illustrator. The reverse image of the final design may then be digitally printed using sublimation inks onto the transfer substrate. Appropriate printers, inks and transfer substrates are known in the art and are available from various suppliers. For example, the transfer substrate may be paper, cardboard, cloth, foil, plastic, film or any other material that can carry ink. In one embodiment of the disclosure, the transfer substrate is transfer paper.

The image on the transfer substrate may then be aligned with the treated area of the base coated fabric. The image is transferred to the base coated fabric using a combination of heat and pressure. Preferably, the image is transferred at a temperature of, e.g., 375° F. to 475° F. and preferably 400° F. to 450° F. The fabric and transfer substrate are pressed together with an applied pressure, e.g., at least 60 pounds per inch, and preferably at least 100 to 120 pounds per inch. The heat and pressure may be applied for 25 to 60 seconds and, preferably, 30 to 45 seconds.

In one embodiment, a high-resolution image is a high-definition image and it may be a photograph or a digitally created image. The image may a black and white image, grey-scale image or, preferably, a colour image. Preferably, the high-resolution image is an image with a DPI value of at least 100 DPI, preferably at least 300 DPI, more preferably at least 600 DPI and most preferably at least 720 to 1200 DPI.

Without being bound by theory, it is postulated that the base coat composition binds to cotton fibers and acts as a medium to absorb the colour pigments of the printing inks, thus enhancing the colour reproduction of the image being transferred. Without the base coat composition, colours only adhere to non-cotton fibers. It is further postulated that the printing inks bind to the silicon or silicon-containing compound of the base coat composition. Silicon has a high melting point (approximately 2200° F.). Sublimating at 400 to 450° F. allows the colours to adhere to or associate with the silicon or silicon-containing compound. When cooled, the colours are maintained in association with the silicon or silicon-containing compound. Without the base coat composition, colours only adhere to the non-cotton fibers, thus creating a dull image.

### EXAMPLES

### Example 1

### T-Shirt Printed According to an Embodiment of the Disclosure Compared to a T-Shirt Printed Using Conventional Methods of Sublimation Printing

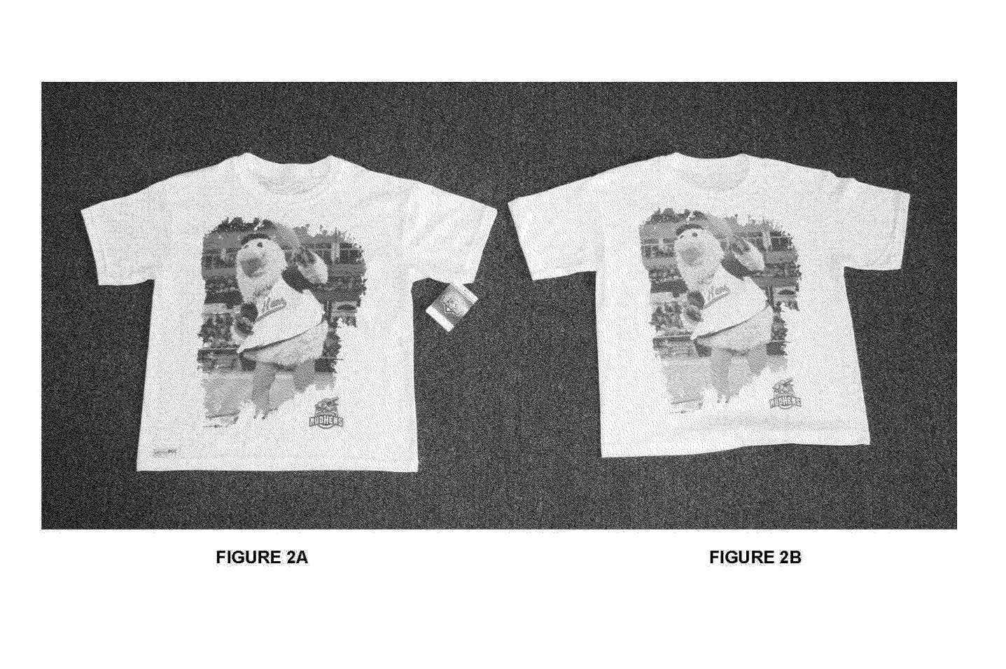

The garment (50/50 blend of cotton and polyester) depicted in FIG. 2A was printed according to the following process.
1. A base coat composition was applied to garment in an amount corresponding to 110 cubic microns per square meter of fabric to be treated to produce a garment with a treated area.
2. The garment was then dried in a drying oven at 340° F. for 40 seconds.
3. A design was printed onto transfer paper.
4. The design on the transfer paper was aligned with the treated area of garment and heat applied to garment at 400 to 450° F. for 30 to 45 seconds.

The garment (50/50 blend of cotton and polyester) depicted in FIG. 2B was printed according to the following process.
1. A design was printed onto transfer paper.
2. The design on the transfer paper was heat applied to the garment at 400 to 450° F. for 30 to 45 seconds.

As exemplified in FIGS. 2A and 2B, the image on the garment shown in FIG. 2A is brighter than the image on the garment shown in FIG. 2B. The image on the garment of FIG. 2A remained bright following repeated laundering.

### Example 2

### Base Coat Composition

A material identification analysis was performed on the base coat composition of Example 1.

The sample was analyzed using a Thermogravimetric Analyzer (TGA) as per ASTM E1131-08 to determine to determine proportions of organic and inorganic matter. The method of analysis and the results obtained are detailed in Table 1.

TABLE 1
Thermogravimetric Analysis

| Parameter | |
|---|---|
| Pre-treatment | None |
| Apparatus | TA Instruments Inc. TGA |
| | Q500 |
| Temperature | Ambient to 1000° C. at 50° C./ |
| Range | min |
| Purge Gas | Ambient to 600° C. - Nitrogen 5.0 Grade |
| | 600° C. to 1000° C. - Air Zeri Grade 0.1 |
| | Flow - 50 mL/min |
| Determinations | Single |

| Results of | | Composition in |
|---|---|---|
| Analysis | Component | Weight |
| | Ambient to 120° C. | 63.60% |
| | (Moisture/Light Volatiles) | |
| | 150 to 300° C. | 22.57% |
| | (Medium Volatile Matter) | |
| | 300 to 550° C. | 10.75% |
| | (Low Volatile Matter) | |
| | 550 to 750° C. | 1.36% |
| | (Combustible Matter) | |
| | Residue >750° C. | 1.72% |
| | (Ash Content) | |

Infrared Analysis, using Fourier Transform Infrared Spectroscopy (FTIR) as per ASTM E1252-98 (2002) was used to determine the nature of the organic resin The composition was placed in an oven for 30 minutes at 60° C. and the dried film was infrascanned and the generated infragraph showed the material to consist of a sodium-based dispersing agent.

Another portion of the composition was analyzed, using Inductively Couple Argon Spectrometry (ICAP) as per ASTM D176-07 (modified), to determine the presence and relative concentration of metallic constituents (Table 2). The generated results showed calcium, magnesium, silicon, sodium and sulphur elements to form the major metallic constituents of the sample.

TABLE 2
Base coat composition

| Element | Concentration (ppm) |
|---|---|
| Aluminum (AL) | 5.3 |
| Antimony (Sb) | <0.1 |
| Arsenic (As) | <0.1 |
| Barium (Ba) | <0.1 |
| Beryllium (Be) | <0.1 |
| Boron (B) | 3.5 |
| Cadmium (Cd) | <0.1 |
| Calcium (Ca) | 429 |
| Chromium (Cr) | <0.1 |
| Cobalt (Co) | <0.1 |
| Copper (Cu) | 1.7 |
| Iron (Fe) | 5.2 |
| Lead (Pb) | <0.1 |
| Magnesium | 104.6 |
| (Mg) | |
| Manganese | <0.1 |
| (Mn) | |
| Mercury (Hg) | <0.1 |
| Molybdenum | <0.1 |
| (Mo) | |
| Nickel (Ni) | <0.1 |
| Phosphorus (P) | 27.4 |
| Potassium (K) | 19.7 |
| Selenium (Se) | <0.1 |
| Silicon (Si) | 105.1 |
| Silver (Ag) | <0.1 |
| Sodium (Na) | 488.7 |
| Strontium (Sr) | 1.9 |
| Sulfur (S) | 220.7 |
| Tin (Sn) | <0.1 |
| Titanium (Ti) | <0.1 |
| Vanadium (V) | <0.1 |
| Zinc (Zn) | 5.1 |
| Zirconium (Zr) | <0.1 |

What has been described above has been intended illustrative and non-limiting and it will be understood by persons skilled in the art that other variances and modifications may be made without departing from the scope of the disclosure as defined in the claims appended hereto.

1. A method for printing a high resolution image onto fabric comprising the steps of:
(a) applying a base coat composition to a fabric;
(b) drying the fabric to obtain a fabric with a base coat; and,
(c) printing a high resolution image onto the base coated fabric, wherein the base coat composition comprises an organosilicon compound.

2. The method of claim 1, wherein the organosilicon compound comprises a siloxane.

3. The method of claim 2, wherein the siloxane comprises polydimethylsiloxane.

4. The method of claim 1, wherein the base coat composition further comprises calcium, magnesium, sodium, sulfur or compounds thereof.

5. The method of claim 1, wherein the base coat composition is applied as a liquid base coat mixture.

6. The method of claim 1, wherein the liquid base coat mixture comprises a solution.

7. The method of claim 1, wherein the solution includes at least one alkali or alkaline earth metal.

8. The method of claim 1, wherein the printing comprises sublimation printing.

9. The method of claim 1, wherein the fabric comprises a natural fiber.

10. The method of claim 9, wherein the fabric comprises cotton or a cotton blend.

11. The method of claim 10, wherein the cotton blend fabric comprises a blend of cotton and polyester.

12. The method of claim 1, wherein the base coat composition is applied using silk screening.

13. The method of claim 1, wherein the base coat composition is applied as a liquid base coat mixture which includes a carrier and the fabric is dried at conditions to remove at least 75% of the carrier.

14. The method of claim 1, wherein the fabric is dried at a temperature of 250 to 400° F. for 15 to 30 seconds.

15. The method of claim 1, wherein the base coat composition is selected to produce the base coat that is not detectable to the human eye.

16. The method of claim 1, wherein the fabric is a light coloured fabric.

17. The method of claim 1, wherein the high-resolution image has a resolution of at least 600 DPI.

18. A fabric comprising a base coat comprising an organosilicon compound, and a high resolution printed image, wherein the base coat comprises an intermediary layer between the fabric layer and the high resolution printed image.

19. The fabric of claim 18, wherein the organosilicon compound is a siloxane.

20. The fabric of claim 19, wherein the siloxane is polydimethylsiloxane.

21. The fabric of claim 18, wherein the base coat further comprises calcium, magnesium, sodium, sulfur or compounds thereof.

22. The fabric of claim 18, wherein the high resolution printed image is printed by sublimation printing.

23. The fabric of claim 18, wherein the fabric layer comprises cotton or a cotton blend.

24. The fabric of claim 23, wherein the cotton blend comprises a blend of cotton and polyester.

25. The fabric of claim 18, wherein the high resolution printed image has a resolution of at least 600 DPI.

26. A fabric produced by the method of claim 1.
